(19) United States
(12) Patent Application Publication
(10) Pub. No.: US 2025/0059655 A1
(43) Pub. Date: Feb. 20, 2025

(54) SOLAR-POWERED AMMONIA AND OXYGEN PRODUCTION SYSTEM

(71) Applicants: KING FAHD UNIVERSITY OF PETROLEUM AND MINERALS, Dhahran (SA); King Abdullah City for Atomic & Renewable Energy (K.A.CARE), Riyadh (SA)

(72) Inventors: Esmail Mohamed Ali MOKHEIMER, Dhahran (SA); Binash IMTEYAZ, Dhahran (SA); Fahad Abdulaziz ALSULAIMAN, Dhahran (SA)

(73) Assignees: KING FAHD UNIVERSITY OF PETROLEUM AND MINERALS, Dhahran (SA); King Abdullah City for Atomic & Renewable Energy (K.A.CARE), Riyadh (SA)

(21) Appl. No.: 18/450,829

(22) Filed: Aug. 16, 2023

(51) Int. Cl. C25B 1/27; C25B 1/04; C25B 9/65; C25B 15/08

(52) U.S. Cl. CPC C25B 1/27; C25B 1/04; C25B 9/65; C25B 15/081

(57) ABSTRACT

A solar-powered ammonia and oxygen production system includes an electrolyzer, a PV cell unit, a heat exchanger, a solar tower, an air separation unit, a boiler, a first compressor, a second compressor and a third compressor, a turbine, a condenser, a water circulation pump, and a catalytic converter. The system utilizes these components to co-produce ammonia and oxygen while generating surplus power. The ambient air intake of the first compressor connects to the heat exchanger, which is thermally coupled to the solar tower. This hot air from the heat exchanger is supplied to the air separation unit. The nitrogen output from the air separation unit feeds into the boiler, and from there, to the catalytic converter. The boiler, turbine, condenser, and water circulation pump form a water/steam unit to rotate the turbine, producing mechanical energy that powers the first and second compressors.

### BACKGROUND

### Technical Field

The present disclosure relates to the field of renewable energy production and storage. More specifically, the present disclosure pertains to a system that utilizes solar energy to efficiently co-produce green ammonia and oxygen, while also generating surplus power.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The modern world faces an urgent need to address energy security and environmental crises, which have escalated to unprecedented levels of global concern. The long-term solution to these dual challenges lies in transitioning towards renewable energy sources and ensuring a clean energy supply for sustainable technological development. Despite numerous efforts, the rate of growth for renewable energy has not been substantial, primarily due to various challenges associated with its implementation. Major obstacles include the need for efficient energy conversion, storage, and long-distance transportation, all of which require further innovation and technological advancement.

Hydrogen energy has been identified as a potential future energy carrier due to its clean nature and the ease with which it can be produced from renewable sources. However, the transportation and storage of hydrogen present significant challenges due to associated hazards and cost inefficiencies. These issues have resulted in need for innovative solutions, particularly in terms of energy carriers that can facilitate the practical utilization of hydrogen energy. One such solution involves converting hydrogen gas into hydrogen-rich compounds that can be liquefied under mild conditions.

Compounds such as ammonia, methane, and methanol have been explored for this purpose. Ammonia, being carbon-free, is a great alternative and is deemed a potential hydrogen energy carrier of the future. Ammonia possesses an energy density of 13.6 GJ/m³ and is characterized by features like liquefaction at room temperature, high volumetric and gravimetric density, and low risk hazards during storage, transportation, and utilization. Furthermore, hydrogen may be easily and efficiently converted to ammonia through well-established processes such as the Haber-Bosch process.

Moreover, various hydrogen production technologies that use renewable energy sources have attained technological and industrial maturity. These include photochemical, thermochemical, and electrochemical techniques. However, hydrogen production is highly energy-intensive, whether achieved through hydrocarbon reforming or water splitting. This necessitates the provision of an energy-efficient design with proper heat recuperation and co-production cycles to effectively reduce the production cost of hydrogen.

Also, generally, there is a significant demand for oxygen for various applications. For instance, oxygen is a critical component in many industrial applications and is also essential for medical purposes. Conventional methods of oxygen production, such as cryogenic air separation and pressure swing adsorption, are energy-intensive and often require large-scale infrastructure, making them less suitable for remote or resource-limited settings. A new technique based on Ion Transport Membranes (ITMs) has opened new possibilities for efficient oxygen production. ITMs have demonstrated the ability to separate oxygen from air with high purity while requiring minimal energy. These membranes operate on the principle of oxygen ion conductivity and selective permeation, which allow oxygen ions to migrate from one side of the membrane to the other under the influence of an oxygen partial pressure gradient.

However, the operational characteristics of ITMs present their own set of challenges. Notably, ITMs typically operate at high temperatures and pressures, which can lead to a significant amount of heat being rejected during operation. This waste heat, if not effectively utilized, contributes to the overall energy inefficiency of the process. Further, the integration of ITMs within a renewable energy system introduces additional complexities. For instance, the intermittent nature of many renewable energy sources, such as solar and wind, complicates the continuous operation of the ITM.

Furthermore, the use of solar energy for powering the above described systems in current form, including hydrogen production system, hydrogen conversion system, or ITM based system, is also limited by efficiency issues. Photovoltaic (PV) panels, for instance, have their efficiency compromised by heat, which reduces the power output. Cooling techniques are needed to enhance the efficiency of these panels, but these techniques themselves often require additional energy input, and carried heat from the PV panels is often wasted, thereby offsetting the benefits.

Thus, it may be noted that while significant advances have independently been made in each of the areas of harnessing renewable energy sources, hydrogen production and conversion, oxygen production, particularly via ITMs, these systems have mostly been developed in silos. There has been no attempt made to integrate these systems and exploit possible synergies, such as, for example, efficiently utilizing the waste heat generated by ITMs and improving the overall energy efficiency of such an integrated system.

Accordingly, it is one object of the present disclosure to provide an integrated system capable of efficiently producing green ammonia and oxygen using renewable energy sources, and specifically, using solar power for both thermal and electrical energy needs. Such integrated system may also need to improve the efficiency of solar PV panels. Moreover, it may be advantageous for such integrated system to have the ability to produce surplus power, making it a beneficial and practical solution for renewable energy production and storage.

### SUMMARY

In an exemplary embodiment, a solar-powered ammonia and oxygen production system is provided. The solar-powered ammonia and oxygen production system includes an electrolyzer having a water inlet, an oxygen outlet and a hydrogen outlet. The solar-powered ammonia and oxygen production system further includes an electrolyzer having a water inlet, an oxygen outlet and a hydrogen outlet. The solar-powered ammonia and oxygen production system further includes a PV cell unit. The solar-powered ammonia and oxygen production system further includes a heat exchanger having a cold air inlet and a hot air outlet. The solar-powered ammonia and oxygen production system further includes a solar tower. The solar-powered ammonia and oxygen production system further includes an air separation unit comprising an ion transport membrane (ITM) and having a hot air inlet, an oxygen outlet and a nitrogen outlet. The solar-powered ammonia and oxygen production system further includes a boiler having a nitrogen boiler inlet and a nitrogen boiler outlet. The solar-powered ammonia and oxygen production system further includes a first compressor. The solar-powered ammonia and oxygen production system further includes a second compressor. The solar-powered ammonia and oxygen production system further includes a third compressor. The solar-powered ammonia and oxygen production system further includes a turbine. The solar-powered ammonia and oxygen production system further includes a condenser. The solar-powered ammonia and oxygen production system further includes a water circulation pump. The solar-powered ammonia and oxygen production system further includes a catalytic converter having a hydrogen inlet, a nitrogen inlet and an ammonia outlet, wherein the hydrogen inlet of the catalytic converter is fluidly connected to the hydrogen outlet of the catalytic converter. Herein, the first compressor has an ambient air inlet and a high pressure air outlet that is fluidly connected to the cold air inlet of the heat exchanger, the heat exchanger is thermally connected to the solar tower, the hot air outlet of the heat exchanger is fluidly connected to the hot air inlet of the air separation unit, the nitrogen outlet of the air separation unit is fluidly connected to the nitrogen boiler inlet of the boiler, and the nitrogen boiler outlet is fluidly connected to the nitrogen inlet of the catalytic converter. Further, herein, the boiler, the turbine, the condenser, and the water circulation pump are fluidly connected and form a water/steam unit configured to rotate the turbine and generate mechanical energy, and the turbine is mechanically connected to the first and second compressors.

In some embodiments, the electrolyzer comprises a solid polymer to catalyze dissociation of water to oxygen and hydrogen.

In some embodiments, the solar tower is in radiative connection with a plurality of reflectors configured a reflect sunlight onto the solar tower and heat a heat transfer medium in the solar tower to a temperature of at least 1200° C. in the heat exchanger.

In some embodiments, the catalytic converter is configured to catalyze reaction of hydrogen and nitrogen to form ammonia at a pressure ranging from 200 bar to 500 bar. In some embodiments, the PV cell unit comprises a PV panel, a thermoelectric generator panel, and a plurality of water channels.

In some embodiments, each water channel of the plurality of water channels runs longitudinally along a long axis of the PV panel. Herein, an upstream end of the water channels includes an inlet header and a downstream end of the water channels includes an outlet header. In some embodiments, the outlet header of the plurality of water channels is in fluid communication with the water inlet of the electrolyzer.

In some embodiments, at least 90% of an area of a back surface of the PV cell unit is in thermal communication with the water channels of the plurality of water channels.

In some embodiments, at least 90% of a back surface of the PV panel is in direct thermal communication with the thermoelectric generator.

In some embodiments, at least 90% of a back surface of the thermoelectric generator is in direct fluid communication with the water channels of the plurality of water channels.

In some embodiments, the PV cell unit is directly adjacent to the electrolyzer and the outlet header of the plurality of water channels is integral with the water inlet of the electrolyzer.

In some embodiments, the solar-powered ammonia and oxygen production system further comprises an ammonia compressor in fluid communication with the ammonia outlet of the catalytic converter.

In some embodiments, a high pressure ammonia outlet of the ammonia compressor is in fluid communication with a pressurizing pump having an outlet in fluid communication with an ammonia storage tank.

In some embodiments, a hydrogen inlet of the third compressor is in fluid communication with the hydrogen outlet of the electrolyzer and a hydrogen outlet of the third compressor is in fluid communication with the hydrogen inlet of the catalytic converter.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of a solar-powered ammonia and oxygen production system, according to an embodiment;

FIG. 2 is a schematic diagram of a solar-powered ammonia and oxygen production system, based on the solar-powered ammonia and oxygen production system of FIG. 1, with additional re-use of heat generated from generation of gases therein, according to an embodiment;

FIG. 3 is a schematic diagram of a solar-powered ammonia and oxygen production system, based on the solar-powered ammonia and oxygen production system of FIG. 2, with a PV cell unit therein having a PV panel associated with a thermoelectric generator panel and comprising a plurality of water channels, according to an embodiment;

FIG. 4 is a planar cross-section view of the PV cell unit for the solar-powered ammonia and oxygen production system of FIG. 3, according to certain embodiments;

FIG. 5 is an exploded perspective view of the PV cell unit for the solar-powered ammonia and oxygen production system of FIG. 3, according to certain embodiments; and

FIG. 6 is a schematic diagram of a solar-powered ammonia and oxygen production system, based on the solar-powered ammonia and oxygen production system of FIG. 3, with the thermoelectric generator panel of the PV cell unit integrated with an electrolyzer therein, according to an embodiment.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a solar-powered ammonia and oxygen production system (“system”) designed for co-production of ammonia and oxygen. Leveraging renewable energy sources, specifically solar power, the system incorporates various components and processes to achieve efficient energy utilization and production. Specifically, the system involves the electrolysis of water to produce hydrogen and oxygen. Further, an air separation process separates nitrogen from air. This nitrogen then reacts with the produced hydrogen in a catalytic converter to form ammonia. The system effectively manages the thermal and electrical energy requirements using solar power only. The system's operation is marked by a high degree of efficiency, achieved through the reuse of heat from various processes and using thermoelectric generation for active cooling and additional power generation. The system is characterized by its carbon-free operation and its use of abundant and readily available raw materials, namely air and water. The result is a renewable energy system capable of co-producing ammonia and oxygen with the added capability of generating surplus power.

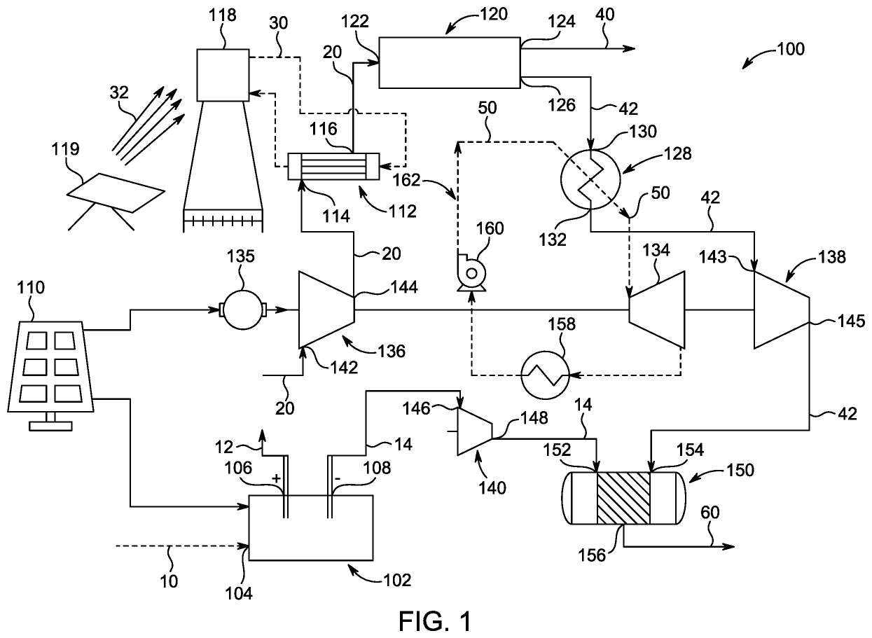

Referring to FIG. 1, illustrated is a solar-powered ammonia and oxygen production system 100 (hereinafter referred to as “system 100”), according to an embodiment of the present disclosure. The system 100 includes several components, each serving a unique function that contributes to the overall operation thereof. In particular, the system 100 is an integration of various components, each performing a unique function to achieve the overall objective of co-producing ammonia and oxygen using solar power, and surplus power generation. The system 100 provides a green technology solution to address various challenges in the fields of renewable energy and chemical production.

As illustrated in FIG. 1, the system 100 includes an electrolyzer 102 having a water inlet 104, an oxygen outlet 106, and a hydrogen outlet 108. The electrolyzer 102 is configured to catalyze dissociation of water into oxygen and hydrogen. For this purpose, water (as represented by reference numeral 10) is introduced into the electrolyzer 102 through the water inlet 104. The electrolyzer 102 applies an electric current to the water 10, causing it to separate into constituent oxygen (as represented by reference numeral 12) and hydrogen (as represented by reference numeral 14), via a process known as electrolysis). That is, as a result of the electrolysis process, the oxygen gas 12 and the hydrogen gas 14 are produced. In particular, the electrolyzer 102 typically consists of an anode and a cathode separated by an electrolyte. When the electric current is applied, the water 10 at the anode is oxidized to produce the oxygen 12 and positively charged hydrogen ions (protons). These protons then migrate through the electrolyte to the cathode, where they are reduced to form the hydrogen gas 14. In this way, the electrolyzer 102 produces both oxygen 12 and hydrogen 14 from the water 10. In the system 100, the oxygen 12 is expelled or escapes from the electrolyzer 102 through the oxygen outlet 106 (to be stored in an oxygen tank or the like), while the hydrogen 14 is expelled or escapes through the hydrogen outlet 108 for further use in the system 100, as discussed later herein.

In an example embodiment, the electrolyzer 102 in the system 100 includes a solid polymer (i.e., a solid polymer-based electrolyte) to catalyze the dissociation of the water 10 into the oxygen 12 and the hydrogen 14. This type of electrolyzer is often referred to as a Polymer Electrolyte Membrane (PEM) electrolyzer (also known as Proton Exchange Membrane electrolyzer). In the PEM electrolyzer, the electrolyte is a solid specialty plastic material. This polymer is permeable to protons when it is saturated with the water 10, but it does not conduct electrons. The core component of the PEM electrolyzer is the membrane electrode assembly (MEA), which includes the polymer electrolyte membrane plus the anode and cathode. The electrolysis process begins when the water 10, supplied to the anode side, is oxidized to produce the oxygen 12, protons (H+ ions), and electrons. The generated protons then migrate through the polymer electrolyte membrane to the cathode side. Simultaneously, the electrons travel through an external circuit, creating the electrical current that powers the electrolyzer. When the protons reach the cathode, they combine with electrons from the external circuit to form the hydrogen gas 14. The electrolyzer 102 utilizing solid polymer have several advantages. Such electrolyzer 102 may be able to operate at high current densities, which means it can produce a large volume of the hydrogen gas 14 within a compact system footprint. The electrolyzer 102 is also capable of rapidly starting and stopping, which makes it well-suited to operate with intermittent power supplies, as required in the present system 100.

The system 100 also includes a Photovoltaic (PV) cell unit 110 configured to generate electric energy from solar power. This electric energy is used to power the electrolyzer 102, facilitating the electrolysis process that produces the oxygen 12 and the hydrogen 14 from the water 10. In particular, the PV cell unit 110 harnesses and converts solar energy into electrical energy (in the form of electric current), which is then supplied to the electrolyzer 102 for the electrolysis process. This solar-to-electrical energy conversion process provides a renewable and environmentally-friendly power source for the electrolyzer 102. Herein, the PV cell unit 110 may use any one of monocrystalline PV cells, polycrystalline PV cells, thin-film PV cells, concentrated PV cells, or the like, without any limitations. The choice may depend on factors such as the available budget, the amount of sunlight available, the desired efficiency, and the specific requirements of the system 100.

The system 100 further includes a heat exchanger 112 having a cold air inlet 114 and a hot air outlet 116. Air (as represented by reference numeral 20) is drawn into the heat exchanger 112 through the cold air inlet 114. The air 20 is then heated in the heat exchanger 112 and subsequently expelled as hot air (as represented by same reference numeral 20) through the hot air outlet 116. For purposes of the present disclosure, the heat exchanger 112 may be of any suitable type, such as, but not limited to, shell and tube heat exchanger, plate heat exchanger, and air cooled heat exchanger. The heat exchanger 112 may, generally, include a series of tubes or plates that create a path for the hot and cold fluids. The heat from the hot fluid is transferred through the wall of the tubes or plates to the cold fluid without the two fluids coming into direct contact. The specific type of the heat exchanger 112 used in the system 100 may depend on various factors such as desired temperature to the air may need to be heated, properties of heat transfer medium, and the operational conditions of the system 100.

The system 100 further includes a solar tower 118. The solar tower 118, also known as solar power tower or central tower receiver, is a type of solar furnace that uses a field of mirrors to concentrate thermal energy of sunlight onto a central receiver located on top of a tower. Herein, the solar tower 118 utilizes a heat transfer medium (as represented by reference numeral 30 in FIG. 1), which could be air, water, oil, molten salts, or other suitable material, to absorb the thermal energy, and subsequently transfer the absorbed thermal energy to where it is needed. In the system 100, the solar tower 118 is thermally connected to the heat exchanger 112, and is configured to transfer the thermal energy, via the heat transfer medium 30, to the heat exchanger 112, which then heats the ambient air 20 into the hot air 20. It may be appreciated that the solar tower 118 generates a significant amount of heat, and may operate at high temperatures, which can improve the efficiencies of processes in the system 100.

In an example embodiment, as illustrated in FIG. 1, the solar tower 118 is in radiative connection with a plurality of reflectors (only one shown and represented by reference numeral 119) that are configured to reflect sunlight (as represented by reference numeral 32) onto the solar tower 118. The solar tower 118 harnesses solar thermal energy from the sunlight 32, which may be in the form of solar radiation, reflected by the plurality of reflectors 119 and uses it to heat the heat transfer medium 30. In an example, the plurality of reflectors 119 may be in the form of heliostats, in which each heliostat is motorized and computer-controlled to track the sun as it moves across the sky, keeping the reflected sunlight 32 focused throughout the day. This concentrated sunlight 32 may generate intense heat, which in the case of the solar tower 118 is used to heat up the heat transfer medium 30. In present examples, the solar tower 118 heats the heat transfer medium 30 to a temperature of at least 1200° C., which is then used to heat the air in the heat exchanger 112.

The system 100 further includes an air separation unit 120. The air separation unit 120 has a hot air inlet 122, an oxygen outlet 124, and a nitrogen outlet 126. The hot air 20 from the heat exchanger 112 enters the air separation unit 120 via the hot air inlet 122. In the present configuration, the air separation unit 120 incorporates an ion transport membrane (ITM, not shown). The ITM is a type of membrane that can selectively transport specific ions from one side to the other. In the present system 100, the ITM in the air separation unit 120 is used to separate oxygen from the hot air 20. The ITM within the air separation unit 120 separates the hot air 20 into oxygen (as represented by reference numeral 40) and nitrogen (as represented by reference numeral 42). The separated oxygen 40 is then discharged from the air separation unit 120 through the oxygen outlet 124 (to be stored in an oxygen tank or the like), while the separated nitrogen 42 is expelled or discharged through the nitrogen outlet 126.

The ITM, as used in the air separation unit 120, is typically made of dense ceramic materials that can conduct oxygen ions at high temperatures. The most commonly used materials for ITM are mixed ionic-electronic conductors (MIECs), which can conduct both oxygen ions and electrons. This dual conduction mechanism allows oxygen molecules from the air to be split into oxygen ions on one side of the membrane, transported through the membrane, and recombined into oxygen molecules on the other side. The operation of the ITM is based on the partial pressure difference of oxygen across the membrane. On a feed side of the ITM, where the hot air (such as, the hot air 20) enters, the partial pressure of oxygen is high. On a permeate side, where the separated oxygen is collected, the partial pressure of oxygen is kept low. This difference in partial pressures drives the transport of oxygen ions from the feed side to the permeate side.

Further, as illustrated, the system 100 includes a boiler 128 with a nitrogen boiler inlet 130 and a nitrogen boiler outlet 132. The system 100 further includes a turbine 134, a first compressor 136, a second compressor 138, and a third compressor 140. The first compressor 136 has an ambient air inlet 142 and a high-pressure air outlet 144. In the system 100, the nitrogen 42 from the air separation unit 120, which carries some heat from the air separation process, enters the boiler 128 via the nitrogen boiler inlet 130. In the boiler 128, the nitrogen 42 is used to generate steam (as represented by reference numeral 50) for the operation of the turbine 134. Herein, the ambient air 20 is, essentially, first drawn into the first compressor 136 through the ambient air inlet 142. In the present system 100, the first compressor 136 is driven by an ambient air pump 135, which may draw power for its operation using the electrical energy generated by the PV cell unit 110. The first compressor 136, compresses the ambient air 20, which is subsequently discharged through the high-pressure air outlet 144. This high-pressure air 20 is then directed to the cold air inlet 114 of the heat exchanger 112. Also, the second compressor 138 has a nitrogen compressor inlet 143 and a nitrogen compressor outlet 145. Herein, the nitrogen 42 from the nitrogen boiler outlet 132 of the boiler 128 is passed to the second compressor 138 via the nitrogen compressor inlet 143. The nitrogen 42 gets compressed in the second compressor 138, and the compressed nitrogen 42 is expelled via the nitrogen compressor outlet 145 therein. Further as illustrated, the third compressor 140 has a hydrogen inlet 146 and a hydrogen outlet 148. The hydrogen inlet 146 of the third compressor 140 is in fluid communication with the hydrogen outlet 108 of the electrolyzer 102 to receive the hydrogen 14 therefrom. The hydrogen 14 gets compressed in the third compressor 140, and the compressed hydrogen 14 is expelled via the hydrogen outlet 148 therein.

The system 100 also includes a catalytic converter 150. The catalytic converter 150 is equipped with a hydrogen inlet 152, a nitrogen inlet 154, and an ammonia outlet 156. The hydrogen outlet 148 of the third compressor 140 is in fluid communication with the hydrogen inlet 152 of the catalytic converter 150. Thereby, the compressed hydrogen 14 from the third compressor 140 is directed to the catalytic converter 150. Also, the nitrogen inlet 154 of the catalytic converter 150 is disposed in fluid communication with the nitrogen compressor outlet 145 of the second compressor 138. Herein, the compressed nitrogen 42 from the second compressor 138 enters the catalytic converter 150 through the nitrogen inlet 154, and the compressed hydrogen 14 from the third compressor 140 enters through the hydrogen inlet 152. The catalytic converter 150 is configured to catalyze reaction of the hydrogen 14 and the nitrogen 42 to form ammonia (as represented by reference numeral 60). The resulting ammonia 60 is then expelled from the catalytic converter 150 through the ammonia outlet 156.

It may be understood that the catalytic converter 150 is responsible for facilitating the chemical reaction between the hydrogen 14 and the nitrogen 42 to form the ammonia 60 in the system 100, via a conversion process often referred to as the Haber-Bosch process. The catalytic converter 150 typically consists of a reaction chamber containing a catalyst that accelerates the combination of the hydrogen 14 and the nitrogen 42 to form the ammonia 60. The catalyst is often made from metals like iron, ruthenium, or osmium, sometimes with additives to enhance its activity. In an example embodiment, the catalytic converter 150 is configured to catalyze the reaction of hydrogen and nitrogen to form the ammonia 60 at a pressure ranging from 200 bar to 500 bar. In an example, the ammonia 60 may be formed at a pressure ranging from 200 bar, 300 bar, 400 bar to 300 bar, 400 bar, 500 bar. The high pressure within the catalytic converter 150 enhances the efficiency of the reaction, resulting in a higher yield of the ammonia 60. Preferably, the catalytic converter 150 contains a ruthenium-calcium-aluminum metal catalyst dispersed in hexagonal vacancies of a synthetic cordierite ceramic support. The ruthenium-calcium-aluminum metal catalyst is preferably dispersed with the hexagonal vacancies in the form of particles and without being directly incorporated in the honeycomb support.

Furthermore, as illustrated, the system 100 includes a condenser 158 and a water circulation pump 160, which are fluidly connected with each other and with the boiler 128 and the turbine 134; and these components including the boiler 128, the turbine 134, the condenser 158 and the water circulation pump 160 together form a closed loop, as a water/steam unit 162. Herein, after the steam 50 has passed through the turbine 134, driving it to produce mechanical work, it needs to be condensed back into water. The condenser 158 achieves this by lowering temperature of the exhaust steam 50, causing it to condense back into liquid water (also referred by same reference numeral 50). The water circulation pump 160 then pumps the condensed water 50 from the condenser 158 back into the boiler 128. The water/steam unit 162 thus completes a thermodynamic cycle, and harnesses the thermal energy produced by the solar tower 118 and the heat exchanger 112, converting it into mechanical energy. This mechanical energy is then used to drive the first compressor 136 and the second compressor 138 (and feasibly the third compressor 140 as well), supporting the overall operation of the system 100.

During operation of the system 100, first, the PV cell unit 110 converts the solar energy into electrical energy, which is then supplied to the electrolyzer 102. The electrolyzer 102 facilitates the reaction that dissociates the water 10 into its elemental components, the oxygen 12 and the hydrogen 14. The hydrogen 14 is passed to the third compressor 140 for compression. In tandem, the first compressor 136 operates to draw in the ambient air 20, which is then compressed and delivered to the heat exchanger 112. The heat exchanger 112, thermally connected to the solar tower 118, receives the heat transfer medium 30 heated by the solar tower 118, and this thermal energy is transferred to the compressed air 20 within the heat exchanger 112, resulting in the hot air 20 which is then directed to the air separation unit 120. The air separation unit 120, equipped with the ITM, takes in the hot air 20 and exploits the oxygen partial pressure gradient across its surfaces to selectively allow the oxygen 40 to permeate through, separating it from the nitrogen 42 which is directed to the boiler 128. The boiler 128 uses heat from the nitrogen 42 to generate the steam 50. This steam 50 is then utilized to drive the turbine 134 to generate mechanical energy, which is used to power the first compressor 136 and the second compressor 138, where the second compressor 138 compresses the nitrogen 42. The catalytic converter 150, receiving the compressed hydrogen 14 from the third compressor 140 and the compressed nitrogen from the second compressor 138, facilitates the Haber-Bosch process, producing the ammonia 60. It may be contemplated that, herein, the compressors 136, 138, and 140 may be powered by electric motor(s) (not shown) initially (using electric energy from the PV cell unit 110), once the cycle is operational, the power may be drawn from the turbine 134 to drive the compressors 136, 138, and 140.

Thereby, the system 100 serves to produce the ammonia 60 and the oxygen 12, 40 using solar power. The system 100 achieves this by integrating a series of components that work in synergy, harnessing solar energy (including the reflected sunlight 32), facilitating the electrolysis of the water 10 to generate the oxygen 12 and the hydrogen 14, compressing and separating the air 20 into the oxygen 40 and the nitrogen 42, reacting the hydrogen 14 with the nitrogen 42 to form the ammonia 60, and efficiently utilizing byproduct heat from generation of the nitrogen 42 from various processes. The system 100 represents a significant advancement in renewable energy technology, providing a solution for the efficient, sustainable co-production of the ammonia 60 and the oxygen 12, 40. The ability of the system 100 to produce the ammonia 60 alongside the oxygen 12, 40 and surplus power (from the PV cell unit 110 and/or the solar tower 118) may provide value in various industrial applications, including but not limited to, fertilizer production, fuel production, and various chemical processes.

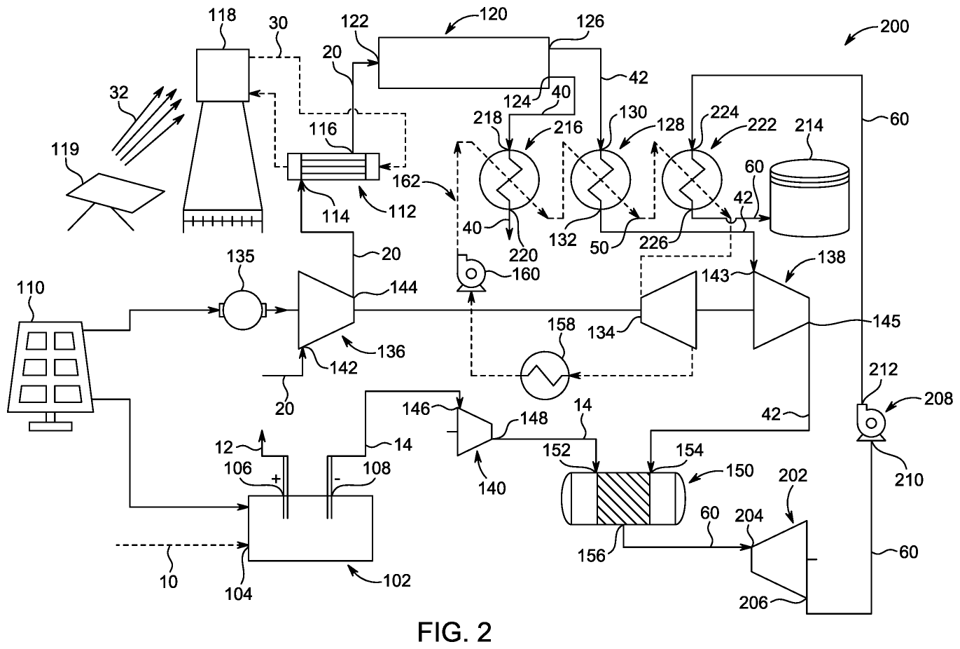

Referring to FIG. 2, illustrated is a schematic diagram of a solar-powered ammonia and oxygen production system 200 (hereinafter referred to as “system 200”), according to an embodiment of the present disclosure. The system 200 includes a number of components similar to the solar-powered ammonia and oxygen production system 100 of FIG. 1 (as previously described), including the electrolyzer 102, the PV cell unit 110, the heat exchanger 112, the solar tower 118, the air separation unit 120, the boiler 128, the turbine 134, the first compressor 136, the second compressor 138, the third compressor 140, the catalytic converter 150, the condenser 158, and the water circulation pump 160. The details about these components are incorporated herein and is not repeated for brevity of the present disclosure. The system 200 further includes additional means for re-using heat generated from the production of gases, enhancing the overall efficiency thereof in comparison to the system 100.

As illustrated, the system 200 includes an ammonia compressor 202 having a low pressure ammonia inlet 204 and a high pressure ammonia outlet 206. The ammonia compressor 202 is disposed in fluid communication with the ammonia outlet 156 of the catalytic converter 150. Specifically, the low pressure ammonia inlet 204 of the ammonia compressor 202 is in fluid communication with the ammonia outlet 156 of the catalytic converter 150, to receive the formed ammonia 60 therefrom which may be carrying some heat energy (from the reaction) therewith. The ammonia compressor 202 compresses the ammonia 60 and dispense the compressed ammonia 60 through the high pressure ammonia outlet 206. The system 200 also includes a pressurizing pump 208 having an inlet 210 and an outlet 212. The inlet 210 of the pressurizing pump 208 is in fluid communication with the high pressure ammonia outlet 206 of the ammonia compressor 202, to receive the compressed ammonia 60 therefrom. The system 200 further includes an ammonia storage tank 214 disposed in fluid communication with the outlet 212 of the pressurizing pump 208.

Therefore, the formed ammonia 60, first, gets compressed and then be pumped by the pressurizing pump 208, for storage in the ammonia storage tank 214. Now since this ammonia 60 to be stored may be at very high temperature, it may need to be cooled down before being transferred to the ammonia storage tank 214 for proper storage. Also, otherwise, the heat in the ammonia 60 may be wasted.

The system 200 incorporates means to re-use of heat generated from generation of gases therein. The system 200 includes a first additional boiler 216 having a first additional boiler inlet 218 and a first additional boiler outlet 220. The first additional boiler inlet 218 is disposed in fluid communication with the oxygen outlet 124 of the air separation unit 120, to receive the oxygen 40 carrying heat energy therewith. The system 200 also includes a second additional boiler 222 having a second additional boiler inlet 224 and a second additional boiler outlet 226. The second additional boiler inlet 224 is disposed in fluid communication with the ammonia outlet 156 of the catalytic converter 150, to receive the formed ammonia 60 (via the ammonia compressor 202 and the pressurizing pump 208) carrying heat energy therewith. As illustrated, in the system 200, the first additional boiler 216 and the second additional boiler 222 are arranged to be part of the water/steam unit 162, along with the boiler 128, the turbine 134, the condenser 158 and the water circulation pump 160 in the closed loop. In particular, the first additional boiler 216, the boiler 128, and the second additional boiler inlet 224 are connected in series with each other.

Herein, the first additional boiler 216 recovers heat from the oxygen 40 produced in the air separation unit 120. The oxygen 40, at the high temperature due to the air separation process, enters the first additional boiler 216 through the first additional boiler inlet 218. In the first additional boiler 216, the heat from the oxygen 40 is transferred to the water 50 coming from the water/steam unit 162, after which the oxygen 40 is expelled out via the first additional boiler outlet 220 and the heated water/steam 50 is moved to the boiler 128. The boiler 128 may then further heat the water/steam 50, as discussed earlier. This further heated water/steam 50 may then be moved to the second additional boiler 222. Further, the second additional boiler 222 recovers heat from the compressed ammonia 60 received through the second additional boiler inlet 224. In the second additional boiler 222, the heat from the ammonia 60 is transferred to the water/steam 50 coming from the boiler 128 in the water/steam unit 162, converting it into steam 50. The ammonia 50, which may now be at a relatively lower temperature, may be passed via the second additional boiler outlet 226 to the ammonia storage tank 214 for storage thereof. Further, herein, the steam 50 is directed to the turbine 134 in the water/steam unit 162, causing it to rotate and generate mechanical energy (as discussed), which may be used to power various components of the system 200.

Therefore, the system 200 operates similarly to the system 100, but with the added feature of heat recovery from the production of gases, including the oxygen 40 and ammonia 60. By incorporating the first additional boiler 216 and the second additional boiler 222 into the system 200, the said heat that would otherwise be wasted, as present in the oxygen 40 and the ammonia 60, can be effectively recovered and converted into mechanical energy. This enhances the overall efficiency of the system 200 and contributes to its sustainability, and makes the system 200 an efficient and eco-friendly solution for the co-production of ammonia and oxygen, as well as the generation of surplus energy.

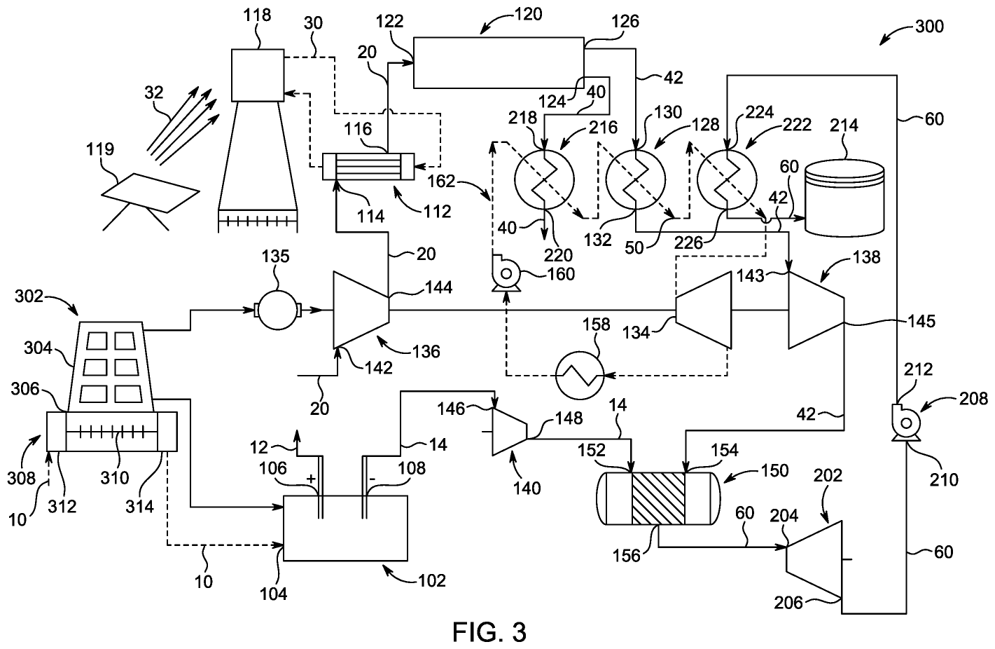

Referring now to FIG. 3, illustrated is a schematic diagram of a solar-powered ammonia and oxygen production system 300 (hereinafter referred to as “system 300”), according to an embodiment of the present disclosure. The system 300 includes a number of components similar to the solar-powered ammonia and oxygen production system 200 of FIG. 2 (as previously described), including the electrolyzer 102, the heat exchanger 112, the solar tower 118, the air separation unit 120, the boiler 128, the turbine 134, the first compressor 136, the second compressor 138, the third compressor 140, the catalytic converter 150, the condenser 158, the water circulation pump 160, the ammonia compressor 202, the pressurizing pump 208, the ammonia storage tank 214, and the first and second additional boilers 216, 222. The details about these components are incorporated herein and is not repeated for brevity of the present disclosure. The system 300 further include means for enhancing performance of harnessing solar energy to generate electrical energy therein, enhancing the overall efficiency thereof in comparison to the system 100, 200.

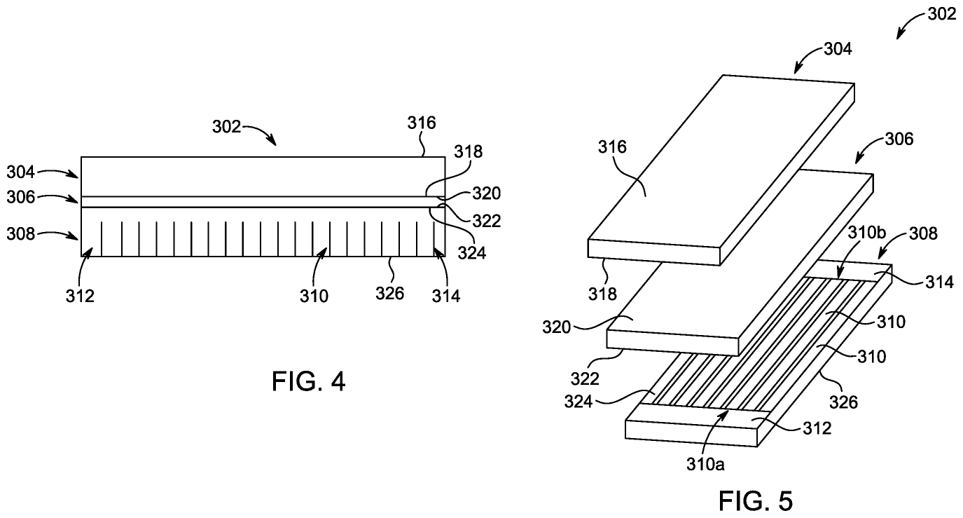

As illustrated in FIG. 3, the system 300 includes a PV cell unit 302 designed to convert solar energy into electrical energy, which is then used to power various components of the system 300 (similar to the PV cell unit 110 of the system 100, 200); however, the PV cell unit 302 includes additional elements in comparison to the PV cell unit 110 of the system 100, 200. Referring to FIGS. 4 and 5, providing different views of the PV cell unit 302, in combination with FIG. 3, as illustrated, the PV cell unit 302 is structured as a layered assembly, with each layer serving a unique role in the functionality thereof. In particular, the PV cell unit 302 includes a PV panel 304, a thermoelectric generator panel 306, and a cooling plate 308. Herein, the PV panel 304 is the primary solar absorption layer, designed to capture and convert solar energy into electrical energy. The thermoelectric generator panel 306 is designed to harvest waste heat from the PV panel 304 and convert it into additional electrical energy. The cooling plate 308 is equipped with a plurality of water channels 310, which run longitudinally along a long axis ‘X’ of the PV panel 304, facilitating a flow of cooling water. These water channels 310 include an inlet header 312 at an upstream end 310a and an outlet header 314 at a downstream end 310b. The cooling plate 308 is configured to manage heat within the PV cell unit 302 and enhance its overall efficiency.

As illustrated, the PV panel 304 forms the topmost layer of the PV cell unit 302. The PV panel 304 has a front surface 316, which is exposed to the sunlight, and a back surface 318. Beneath the PV panel 304, and in direct thermal communication with its back surface 318, is the thermoelectric generator panel 306. The thermoelectric generator panel 306 has a front surface 320 in direct thermal contact with the back surface 318 of the PV panel 304, and a back surface 322. The bottommost layer of the PV cell unit 302 is the cooling plate 308. The cooling plate 308 has a front surface 324, which is in direct thermal contact with the back surface 322 of the thermoelectric generator panel 306, and a back surface 326.

In the PV cell unit 302, the PV panel 304 may be made up of several individual PV cells, each of which generates electricity when exposed to light. The generated electricity is then collected and directed to the electrolyzer 102, and optionally the electric motor(s) powering the compressors 136, 138, and 140, among other components. The thermoelectric generator panel 306 operates on the principle of the Seebeck effect, where a temperature differential across the front surface 320 and the back surface 322 creates a voltage difference, thereby generating additional electricity. This additional electricity may also be directed to various components of the system 300, augmenting the electricity produced by the PV panel 304. It may be appreciated that, herein, the thermoelectric generator panel 306 serves a dual function of generating additional electricity and cooling down the PV panel 304, thereby enhancing its efficiency. The cooling plate 308 aids in managing the heat produced by the PV panel 304 and the thermoelectric generator panel 306. The cooling plate 308 receives the water 10 (from some water source), via the inlet header 312, and this water 10 is circulated in water channels 310 to absorb the heat from the thermoelectric generator panel 306. This leads to a significant temperature gradient across the thermoelectric generator panel 306, enhancing its efficiency. The water 10, now heated, exits the water channels 310 via the outlet header 314.

It may be contemplated by a person skilled in the art that the layered design of the PV cell unit 302 enhances its thermal management capabilities. In an example embodiment, at least 90% of an area of the back surface 326 of the cooling plate 308 (and thus the PV cell unit 302) is in thermal communication with the water channels of the plurality of water channels 310. This significant coverage ensures an efficient heat exchange between the cooling plate 308 and the water 10 flowing through the water channels 310, aiding in effectively managing and utilizing the heat within the system 300. Also, at least 90% of the back surface 318 of the PV panel 304 is in direct thermal communication with the thermoelectric generator panel 306, or specifically the top surface 320 of the thermoelectric generator panel 306. This extensive contact area ensures maximum heat transfer from the PV panel 304 to the thermoelectric generator panel 306, thereby enhancing the thermal management of the PV panel 304 and increasing the heat available for conversion into electrical energy by the thermoelectric generator panel 306. Further, at least 90% of the back surface 322 of the thermoelectric generator panel 306 is in direct fluid communication (thermal contact) with the front surface 324 of the cooling plate 308, and thereby the water channels of the plurality of water channels 310. Consequently, the heat absorbed by the thermoelectric generator panel 306 from the PV panel 304 can be effectively transferred to the cooling plate 308. This arrangement further facilitates the heat exchange with the water flowing through the water channels 310, thus enhancing the overall efficiency of the system 300.

Further, as illustrated in FIG. 3, the outlet header 314 of the water channels 310 is in fluid communication with the water inlet 104 of the electrolyzer 102. The water 10 exits the water channels 310 via the outlet header 314 and is directed to the water inlet 104 of the electrolyzer 102. The water 10, which helped to cool down the PV cell unit 302 and is pre-heated, enters the electrolyzer 102 and further improves the efficiency of the electrolysis process due to it being pre-heated. Thereby, this configuration not only provides a cooling mechanism for the PV cell unit 302 but also pre-heats the water 10 entering the electrolyzer 102, thereby enhancing the efficiency of the electrolysis process. As a result, this integrated PV cell unit 302 serves to augment the electrical energy production of the system 300 and improve the efficiency of the electrolyzer 102.

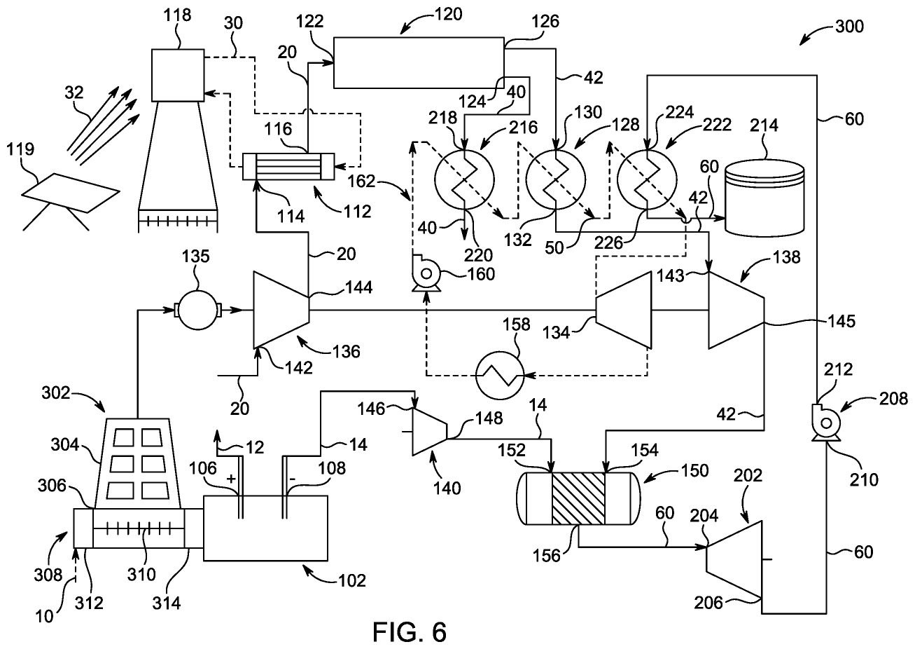

Referring to FIG. 6, illustrated is a schematic diagram of a solar-powered ammonia and oxygen production system 600 (hereinafter referred to as “system 600”), according to an embodiment of the present disclosure. The system 600 shares similarities with the solar-powered ammonia and oxygen production system 300 of FIG. 3 (as previously described), including the electrolyzer 102, the heat exchanger 112, the solar tower 118, the air separation unit 120, the boiler 128, the turbine 134, the first compressor 136, the second compressor 138, the third compressor 140, the catalytic converter 150, the condenser 158, the water circulation pump 160, the ammonia compressor 202, the pressurizing pump 208, the ammonia storage tank 214, the first additional boiler 216, the second additional boiler 222, and the PV cell unit 302 including the PV panel 304, the thermoelectric generator panel 306, and the plurality of water channels 310 therein. However, in the system 600, the thermoelectric generator panel 306 of the PV cell unit 302 is integrated with the electrolyzer 102, to further enhance the overall efficiency of the system 600 in comparison to the system 300.

In particular, in the system 600, the PV cell unit 302 is directly adjacent to the electrolyzer 102. The outlet header 314 of the plurality of water channels 310 is designed to be integral with the water inlet 104 of the electrolyzer 102. This unique positioning and integration allows for a direct and efficient heat transfer from the PV cell unit 302 to the electrolyzer 102. Specifically, the direct adjacency and integration of the PV cell unit 302 and the electrolyzer 102 facilitate an efficient heat transfer from the cooling plate 308 to the electrolyzer 102 through the integrated water channels 310 and the water inlet 104. Herein, the water 10 flowing through the water channels 310 can absorb the heat from the cooling plate 308 and carry it directly into the electrolyzer 102, thus effectively cooling down the PV cell unit 302 and at the same time providing the heat necessary for the electrolysis process within the electrolyzer 102. Moreover, the heat generated by the PV panel 304 and converted into electrical energy by the thermoelectric generator panel 306 can be used to power the electrolyzer 102. This arrangement further enhances the overall efficiency of the system 600 by enabling an efficient management of the heat and a more effective utilization of the generated heat therein.

Therefore, the solar-powered ammonia and oxygen production systems 100, 200, 300, 600 provide an integration of various components and processes to co-produce ammonia and oxygen while concurrently generating surplus power. By utilizing solar power, the systems 100, 200, 300, 600 provide a sustainable and renewable source of energy, which drastically reduces the reliance on fossil fuels for energy generation. The synergistic integration of various components optimizes performance and minimizes energy wastage in the systems 100, 200, 300, 600. Further, the re-use of heat by utilizing additional boilers 216, 222 help improve overall energy efficiency for the systems 200, 300, 600. Furthermore, the use of thermoelectric generator (TEG) panel 306 and the method of heat recovery and re-utilization further enhance overall energy efficiency, specifically, for the systems 300, 600. Thus, the present disclosure is pivotal in combating climate change by significantly lowering the carbon footprint associated with the production of ammonia and oxygen, two gases with extensive applications in various industrial sectors.

Numerous modifications and variations of the present disclosure are possible in light of the above teachings. It is therefore to be understood that within the scope of the appended claims, the present invention may be practiced otherwise than as specifically described herein.

1. A solar-powered ammonia and oxygen production system, comprising:
an electrolyzer having a water inlet, an oxygen outlet and a hydrogen outlet;
a PV cell unit comprising a PV panel, a thermoelectric generator panel, and a plurality of water channels;
a heat exchanger having a cold air inlet and a hot air outlet;
a solar tower;
an air separation unit comprising an ion transport membrane (ITM) and having a hot air inlet, an oxygen outlet and a nitrogen outlet;
a boiler having a nitrogen boiler inlet and a nitrogen boiler outlet;
a first compressor;
a second compressor;
a third compressor;
a turbine;
a condenser;
a water circulation pump; and
a catalytic converter having a hydrogen inlet, a nitrogen inlet and an ammonia outlet, wherein the hydrogen inlet of the catalytic converter is fluidly connected to the hydrogen outlet of the electrolyzer,
wherein the first compressor has an ambient air inlet and a high pressure air outlet that is fluidly connected to the cold air inlet of the heat exchanger, wherein the heat exchanger is thermally connected to the solar tower, wherein the hot air outlet of the heat exchanger is fluidly connected to the hot air inlet of the air separation unit, the nitrogen outlet of the air separation unit is fluidly connected to the nitrogen boiler inlet of the boiler, and the nitrogen boiler outlet is fluidly connected to the nitrogen inlet of the catalytic converter, and
wherein the boiler, the turbine, the condenser, and the water circulation pump are fluidly connected and form a water/steam unit configured to rotate the turbine and generate mechanical energy, wherein the turbine is mechanically connected to the first and second compressors.

2. The system of claim 1, wherein the electrolyzer comprises a solid polymer to catalyze dissociation of water to oxygen and hydrogen.

3. The system of claim 1, wherein the solar tower is in radiative connection with a plurality of reflectors configured to reflect sunlight onto the solar tower and heat a heat transfer medium in the solar tower to a temperature of at least 1,200° C. in the heat exchanger.

4. The system of claim 1, wherein the catalytic converter is configured to catalyze reaction of hydrogen and nitrogen to form ammonia at a pressure ranging from 200 bar to 500 bar.

5. The system of claim 1, wherein the catalytic converter comprises a ruthenium-calcium-aluminum metal catalyst dispersed in hexagonal vacancies of a synthetic cordierite ceramic support.

6. The system of claim 1, wherein each water channel of the plurality of water channels runs longitudinally along a long axis of the PV panel, wherein an upstream end of the water channels includes an inlet header and a downstream end of the water channels includes an outlet header.

7. The system of claim 6, wherein the outlet header of the plurality of water channels is in fluid communication with the water inlet of the electrolyzer.

8. The system of claim 7, wherein at least 90% of an area of a back surface of the PV cell unit is in thermal communication with the water channels of the plurality of water channels.

9. The system of claim 8, wherein at least 90% of a back surface of the PV panel is in direct thermal communication with the thermoelectric generator.

10. The system of claim 9, wherein at least 90% of a back surface of the thermoelectric generator is in direct fluid communication with the water channels of the plurality of water channels.

11. The system of claim 10, wherein the PV cell unit is directly adjacent to the electrolyzer and the outlet header of the plurality of water channels is integral with the water inlet of the electrolyzer.

12. The system of claim 1, further comprising:
an ammonia compressor in fluid communication with the ammonia outlet of the catalytic converter.

13. The system of claim 12, wherein a high pressure ammonia outlet of the ammonia compressor is in fluid communication with a pressurizing pump having an outlet in fluid communication with an ammonia storage tank.

14. The system of claim 1, wherein a hydrogen inlet of the third compressor is in fluid communication with the hydrogen outlet of the electrolyzer and a hydrogen outlet of the third compressor is in fluid communication with the hydrogen inlet of the catalytic converter.
